(19) United States
(12) Patent Application Publication
(10) Pub. No.: US 2012/0191532 A1
(43) Pub. Date: Jul. 26, 2012

(54) METHOD AND APPARATUS FOR PROVIDING ADVERTISEMENT SERVICE

(75) Inventor: Bo-Sun JUNG, Seongnam-si (KR)

(73) Assignee: Samsung Electronics Co., Ltd., Suwon-si (KR)

(21) Appl. No.: 13/355,040

(22) Filed: Jan. 20, 2012

(30) Foreign Application Priority Data
Jan. 20, 2011 (KR) 10-2011-0005840

(51) Int. Cl. G06Q 30/02

(52) U.S. Cl. 705/14.43; 705/14.45

(57) ABSTRACT

A method and apparatus for providing an advertisement service are provided. The method includes receiving advertisement content; detecting use of the received advertisement content; recording information containing an advertisement content use history when detecting the use of the advertisement content; and transmitting the information containing the advertisement content use history to an advertisement service server.

### PRIORITY

This application claims priority under 35 U.S.C. §119(a) to a patent application filed in the Korean Intellectual Property Office on Jan. 20, 2011 and assigned Serial No. 10-2011-0005840, the entire disclosure of which is incorporated herein by reference.

### BACKGROUND OF THE INVENTION

1. Field of the Invention

The present invention relates generally to a method and apparatus for providing an advertisement service, and more particularly, to a method and apparatus for providing an advertisement service in a wired/wireless communication system.

2. Description of the Related Art

As the use of communication terminals increases, attention has been drawn to advertisement services using such communication terminals. Conventional advertisement service systems include communication between a server and user terminals. In conventional advertisement service systems, user terminals connect to a server to download advertisement content from the server, or the server directly transmits (e.g., pushes) advertisement content to unspecified user terminals.

However, the above advertisement service systems are inefficient in terms of the advertisement effect. That is, when advertisement content is provided to user terminals connecting to the server, it is inefficient in that advertisement targets are limited to user terminals connecting to the server. Also, when the server directly transmits advertisement content to unspecified user terminals, there is a high possibility that the relevant users may treat the advertisement as a spam advertisement.

Thus, there is a need to provide an advertisement service that is efficient in terms of the advertisement effect.

### SUMMARY OF THE INVENTION

An aspect of the present invention is to substantially solve at least the above problems and/or disadvantages and to provide at least the advantages below. Accordingly, an aspect of the present invention is to provide a method and apparatus for providing an advertisement service to a user terminal.

Another aspect of the present invention is to provide a method and apparatus for providing an advertisement service considering the characteristics of a terminal user.

Another aspect of the present invention is to provide a method and apparatus for sharing advertisement content by performing an ad-hoc connection between user terminals in a wired/wireless communication system.

Another aspect of the present invention is to provide a method and apparatus for sharing advertisement content between user terminals of the same advertisement preference field in a wired/wireless communication system.

According to an aspect of the present invention, a method of a terminal for providing an advertisement service is provided. The method includes receiving advertisement content; detecting use of the received advertisement content; recording information containing an advertisement content use history when detecting the use of the advertisement content; and transmitting the information containing the advertisement content use history to an advertisement service server.

According to another aspect of the present invention, an apparatus of a terminal for providing an advertisement service is provided. The apparatus includes a communication module for receiving advertisement content; and a control unit for detecting use of the received advertisement content, recording information containing an advertisement content use history when detecting the use of the advertisement content, and transmitting the information containing the advertisement content use history to an advertisement service server.

### BRIEF DESCRIPTION OF THE DRAWINGS

The above and other aspects, objects, features and advantages of the present invention will become more apparent from the following detailed description when taken in conjunction with the accompanying drawings in which:

FIG. 1 is a diagram illustrating a system for providing an advertisement service according to the present invention;

FIG. 2 is a flowchart illustrating a signal flow for sharing an advertisement service between user terminals according to an embodiment of the present invention;

FIG. 3 is a block diagram of a user terminal according to an embodiment of the present invention;

FIG. 4 is a flowchart illustrating an operation process of using advertisement content in a user terminal according to an embodiment of the present invention; and

FIG. 5 is a flowchart illustrating an operation process of sharing advertisement content between a user terminal and another user terminal according to an embodiment of the present invention.

### DETAILED DESCRIPTION OF EMBODIMENTS OF THE PRESENT INVENTION

Embodiments of the present invention will be described herein below with reference to the accompanying drawings. In the following description, detailed descriptions of well-known functions or configurations will be omitted since they would unnecessarily obscure the subject matters of the present invention. Also, the terms used herein are defined according to the functions of the present invention. Thus, the terms may vary depending on users' or operators' intentions or practices. Therefore, the terms used herein must be understood based on the descriptions made herein.

Embodiments of the present invention provide a method and apparatus for providing an advertisement service considering the characteristics of users and sharing advertisement content between user terminals of the same advertisement preference field. In the following description, advertisement content is be any advertisement content that contains information such as messages or images relevant to commercial products. Examples of advertisement content include audio files, image files, video files, and application files. Further, in the following description, a user terminal (or a terminal) is any terminal capable of wireless or wired communication. Examples of the user terminal include mobile terminals, TeleVisions (TVs), and Personal Computers (PCs).

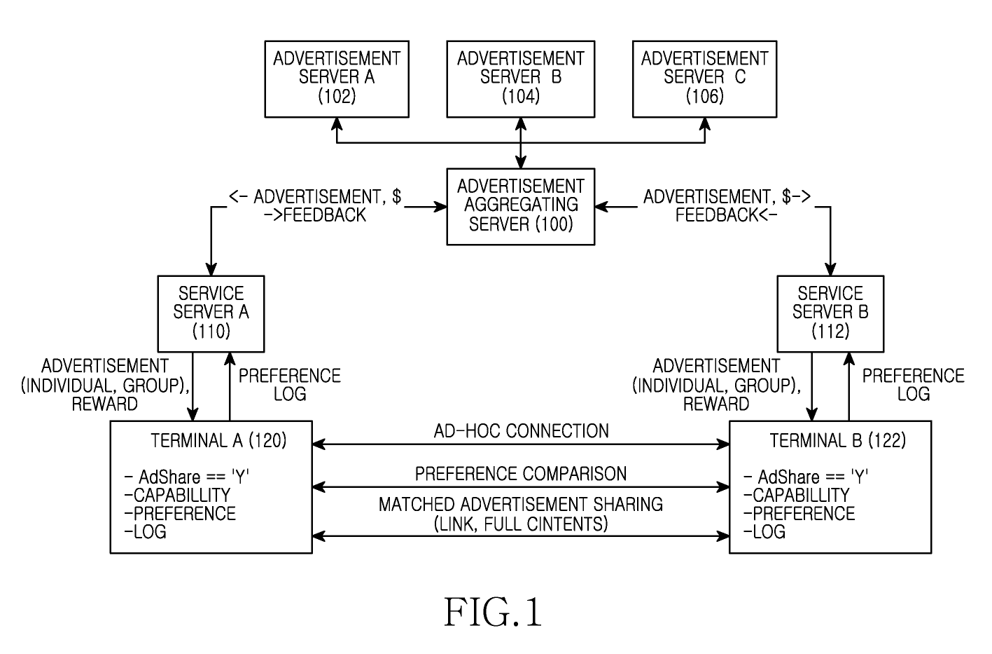

FIG. 1 is a diagram illustrating a system configuration for providing an advertisement service according to the present invention.

Referring to FIG. 1, advertisement servers A 102, B 104 and C 106 produce and store advertisement content for products and provide the content to an advertisement-aggregating server 100. The advertisement servers A 102, B 104 and C 106 are advertisers that register advertisement content in the advertisement-aggregating server 100 and request distribution of the advertisement content to user terminals.

The advertisement-aggregating server 100 collects advertisement content from the advertisement servers A 102, B 104 and C 106 and stores and manages the content. In particular, the advertisement-aggregating server 100 provides the advertisement content to service servers A 110 and B 112 and receives the feedback of use information of the advertisement content from the service servers A 110 and B 112. For example, the advertisement-aggregating server 100 receives the feedback of information about a terminal or terminal group using specific advertisement content and use frequency information of the specific advertisement content. The feedback information is used by the advertisement-aggregating server 100 and the advertisement servers A 102, B 104 and C 106 to produce advertisements preferred by user terminals. The advertisement-aggregating server 100 pays fees for the feedback information and the distribution of the advertisement content to the service server A 110 and B 112.

The service servers A 110 and B 112 receive advertisement content from the advertisement-aggregating server 100 and transmit the received advertisement content to user terminals A 120 and B 122. When the user terminal A 120 and B 122 connects to or is connecting to the service server A 120 and B 122, the service server A 120 and B 122 provides the advertisement content to the user terminal A 120 and B 122 according to events at a user's request or a specific event at the server, or transmits (e.g., pushes) the advertisement content to the user terminal A 120 and B 122 regardless of a users' request. The service server A 110 and B 112 transmits the advertisement content to the user terminal A 120 and B 122 by any suitable method. The service server A 110 and B 112 receives the feedback of advertisement preference field and advertisement content use log information from the user terminal A 120 and B 122 and determine which advertisement content is to be provided to the user terminal A 120 and B 122. For example, if the advertisement preference field of the user terminal A 120 is “Car” and if the advertisement content uses log information is “Advertisement content type: video, average content user time: 15 seconds,” the service server A 110 provides the user terminal A 120 with advertisement content produced in a video of less than 15 seconds, among the car advertisement content.

The user terminal A 120 and B 122 receives advertisement content from the service server A110 and B 112. When detecting the use of the advertisement content based on the user's control, the user terminal A 120 and B 122 analyzes the user's present content use status, analyzes the user's advertisement preference field, and records log information generated according to the use of the advertisement content. The log information represents information and operations relevant to advertisement content in the user terminal A 120 and B 122. Examples of the log information include an average advertisement content use time, an advertisement content use period, an advertisement content use pattern, an advertisement content sharing time, shared advertisement content, and an advertisement content sharing pattern. The user terminal A 120 and B 122 transmits the advertisement preference field and the advertisement content use log information to the service server A 110 and B 112 at predetermined periods or by a predetermined method.

The advertisement servers A 102, B 104 and C 106, the advertisement-aggregating server 100, and the service servers A 110 and B 112 are logical entities, which may be implemented in separate physical servers or may be integrated into a single physical server.

According to an embodiment, the user terminal A 120 and B 122 performs an advertisement sharing function by ad-hoc connection. When an advertisement sharing function is set therein, the user terminal A 120 and B 122 determines whether there is a peripheral terminal having an advertisement sharing function. If there is a peripheral terminal having an advertisement sharing function, the user terminal A 120 and B 122 performs an advertisement sharing function by ad-hoc connection with the peripheral terminal. In order to share an advertisement with the peripheral terminal, the user terminal A 120 and B 122 creates an advertisement sharing profile beforehand which includes its own capability, advertisement preference field, and advertisement content use log information and communicates with the peripheral terminal. For example, if an advertisement sharing function is set in the user terminals A 120 and B 122 and if the user terminals A 120 and B 122 are in wired connection or are located within an adjacent distance capable of ad-hoc connection, the user terminal A 120 transmits an advertisement sharing profile including its own capability, advertisement preference field, advertisement content list, and advertisement content use log information to the user terminal B 122 and the user terminal B 122 transmits an advertisement sharing profile including its own capability, advertisement preference field, advertisement content list, and advertisement content use log information to the user terminal A 120. Upon exchanging the advertisement sharing profiles with each other, the user terminals A 120 and B 122 compare their advertisement preference fields. If their advertisement preference fields are identical to one another, the user terminal A 120 and B 122 detects advertisement content, which are not owned by the counterpart user terminal, on the basis of its advertisement content list and shares the detected advertisement content with the counterpart user terminal. Herein, the user terminal A 120 and B 122 provides only Uniform Resource Locator (URL) information of the detected advertisement content to the counterpart user terminal or provides the detected advertisement content to the counterpart user terminal.

The user terminal A 120 and B 122 automatically provides the counterpart user terminal with the sharable advertisement content, or provides the counterpart user terminal with only advertisement content selected from a plurality of sharable advertisement content by its user. Also, upon receiving the advertisement content, the user terminal stores the received advertisement content and displays the stored advertisement content to the user selectively according to the user's selection, or consumes the received advertisement content without storing the same. In another embodiment, the user terminal selectively receives the advertisement content of the counterpart user terminal in consideration of its storage capacity. In another embodiment, the user terminal provides and uses advertisement content according to its policy or a predetermined policy of a user terminal group. For example, the advertisement content is exchanged between the user terminals on a one-to-one basis. As another example, the user terminal receives additional advertisement content from the counterpart user terminal by providing advertisement content to the counterpart user terminal one or more times when receiving advertisement content from the counterpart user terminal three or more times.

The user terminals A 120 and B 122 share advertisement content with one another as described above, and transmit information thereof to the service servers A 110 and B 112. Accordingly, the service servers A 110 and B 112 discount the fees of the user terminals A 120 and B 122 or pay an additional compensation, thus making it possible to promote the advertisement service.

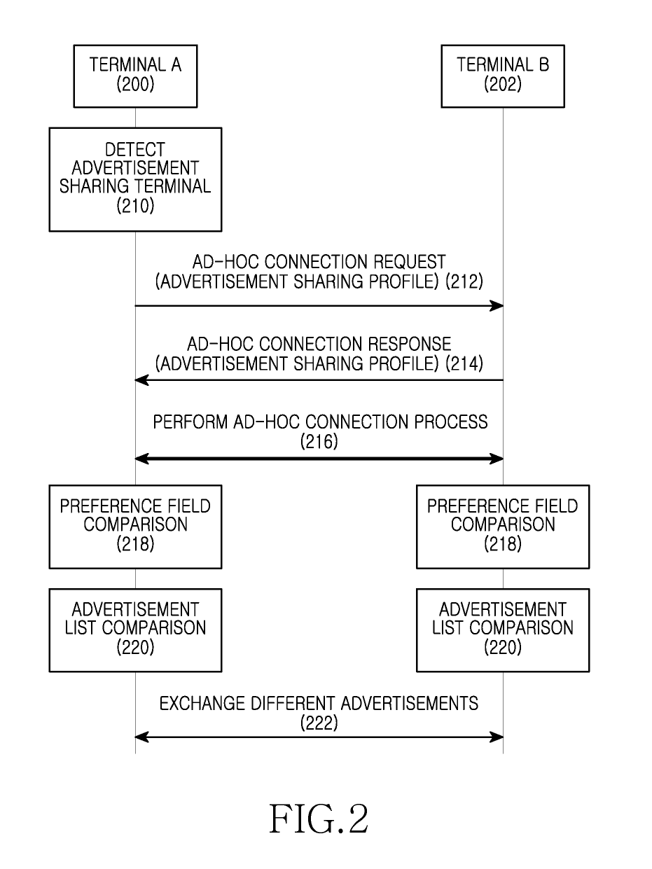

FIG. 2 is a flowchart illustrating a signal flow for sharing an advertisement service between user terminals according to an embodiment of the present invention. Herein, it is assumed that an advertisement sharing function is set in a terminal A 200 and a terminal B 202.

Referring to FIG. 2, the terminal A 200 detects the presence of an advertisement sharing target terminal in step 210. In an embodiment of the present invention, the terminal A 200 detects the presence of a peripheral advertisement sharing target terminal by transmitting/receiving an advertisement sharing request/response signal to/from the peripheral advertisement sharing target terminal according to a predetermined process. In another embodiment, the terminal A 200 detects the presence of a peripheral advertisement sharing target terminal by receiving an advertisement sharing request signal from the peripheral advertisement sharing target terminal. In another embodiment, the terminal A 200 detects the presence of a peripheral advertisement sharing target terminal on the basis of its location information. For example, if the terminal B 202 (as an advertisement sharing target terminal) is an indoor fixed terminal, the terminal A 200 detects the presence of the terminal B 202 at its periphery by receiving a signal transmitted periodically by the terminal B 202, or by comparing its location information with the location information of the terminal B 202. As another example, the terminal A 200 detects the presence of an advertisement sharing target terminal when connected with the advertisement sharing target terminal in a wired manner.

Upon detecting an advertisement sharing target terminal at its periphery, the terminal A 200 transmits an ad-hoc connection request signal to the terminal B (as the advertisement sharing target terminal) in step 212. In step 214, the terminal B transmits an ad-hoc connection response signal to the terminal A 200. In steps 212 and 214, the terminal A 200 and the terminal B 202 communicate advertisement sharing profiles with each other. As shown in Table 1 below, the advertisement sharing profile includes information that is to be exchanged between the advertisement sharing terminals.

TABLE 1

| field name | Description |
|---|---|
| AdShare | indicates whether the terminal will share |
| | advertisement content with another terminal |
| Public | indicates whether the terminal will share |
| | advertisement content with unspecified terminal |
| AdShare > Target | represents a target terminal or a target terminal |
| | group that will share advertisement content |
| Capability | represents capability information of the terminal |
| Preference | represents a user's advertisement preference field |
| Log | represents various log information generated |
| | according to the use of advertisement content by the |
| | user |
| PreferedNetwork | represents a preferred ad-hoc connection scheme |
| StoredAdList | represents a list of advertisement content stored in |
| | the terminal |
| Extension | represents additional information |

In Table 1, “AdShare” is information indicating whether the terminal will share advertisement content with another terminal, in which “Y” indicates that the terminal will share advertisement content with another terminal and “N” indicates that the terminal will not share advertisement content with another terminal. “Public” is information indicating whether the terminal will share advertisement content with unspecified terminals (e.g., TVs and PCs in public places), in which “Y” indicates that the terminal will share advertisement content with an unspecified terminal and “N” indicates that the terminal will not share advertisement content with an unspecified terminal. “AdShare>Target” represents a target terminal or a target terminal group that will share advertisement content with the terminal if “Public” is set to “N” to indicate that the terminal will not share advertisement content with an unspecified terminal. “Capability” is capability information of the terminal, which represents the terminal's screen size, User Agent Profile (UAProf), and Device Capability (DCAP). The UAProf and DCAP represent the terminal's function, performance and user information, which is used in a capability negotiation process between terminals. “Preference” represents the user's advertisement preference field, which is directly set by the user or automatically set according to the user's present content use status. “Log” represents various log information generated according to the use of advertisement content by the user. “PreferedNetwork” represents a preferred ad-hoc connection scheme, examples of which include wireless connection schemes such as Bluetooth® and WiFi® and wired connection schemes such as Universal Serial Bus (USB) and Institute of Electrical and Electronics Engineers (IEEE) 1394. “StoredAdList” represents a list of advertisement content stored in the terminal, which includes URL information of each of the advertisement content, priority information depending on the user's use count and time, or various characteristic information of each of the stored advertisement content. “Extension” includes information other than the above information about advertisement content, or additional information about the above information.

As shown in Table 1, the advertisement sharing profile includes the necessity of advertisement sharing, an advertisement sharing target terminal, the capability of a terminal, an advertisement preference field, advertisement content use log information, a network, and an advertisement content list.

After exchanging the advertisement sharing profiles through the ad-hoc connection request/response signals, the terminal A 200 and the terminal B 202 performs an ad-hoc connection process in step 216. The ad-hoc connection process is determined with reference to the “PreferedNetwork” information (i.e., the preferred ad-hoc connection scheme) included in the advertisement sharing profile. The terminal A 200 and the terminal B 202 is connected through a wired cable.

In step 218, the terminal A 200 and the terminal B 202 then each compares its own advertisement preference field and the advertisement preference field of the counterpart terminal on the basis of its own advertisement sharing profile and the advertisement sharing profile of the counterpart terminal.

If a terminal's own advertisement preference field is identical to the advertisement preference field of the counterpart terminal, the terminal A 200 and the terminal B 202 compares its own advertisement content list and the advertisement content list of the counterpart terminal on the basis of its own advertisement sharing profile and the advertisement sharing profile of the counterpart terminal in step 220. In step 222, the terminal A 200 and the terminal B 202 then transmits advertisement content, which are present in its own advertisement content list but not in the advertisement content list of the counterpart terminal, to the counterpart terminal, and receives advertisement content, which are present in the advertisement content list of the counterpart terminal but not in its own advertisement content list, from the counterpart terminal to share the advertisement content with one another. When the connection between the terminals A 200 and B 202 is interrupted, the terminal A 200 and the terminal B 202 downloads the relevant advertisement content through the relevant advertisement's URL from the advertisement content list included in the advertisement sharing profile.

The terminals A 200 and B 202 selectively requests and share desired advertisement content by additional request/response steps (not illustrated) in the ad-hoc connection request/response process. For example, the terminal A 200 transmits an ad-hoc connection request including information about desired advertisement content to the terminal B. The terminal B transmits an ad-hoc connection response to the terminal A to inform the terminal A 200 whether it has the advertisement content desired by the terminal A 200, or perform an ad-hoc connection process without the ad-hoc connection response and transmit the advertisement content desired by the terminal A 200. For example, after detecting the presence/absence of the desired advertisement content in the terminal B 202 through the ad-hoc connection response, the terminal A 200 receives the desired advertisement content through an ad-hoc connection process. As another example, after detecting the presence/absence of the desired advertisement content in the terminal B through the ad-hoc connection response, the terminal A 200 receives the desired advertisement content through an additional request process (not illustrated). As another example, upon detecting the exchanged profile, the terminal A requests desired advertisement content from the terminal B 202 according to a specific genre, a length, or a user's selection (not illustrated). At the request of the terminal A 200, the terminal B 202 transmits the desired advertisement content to the terminal A 200.

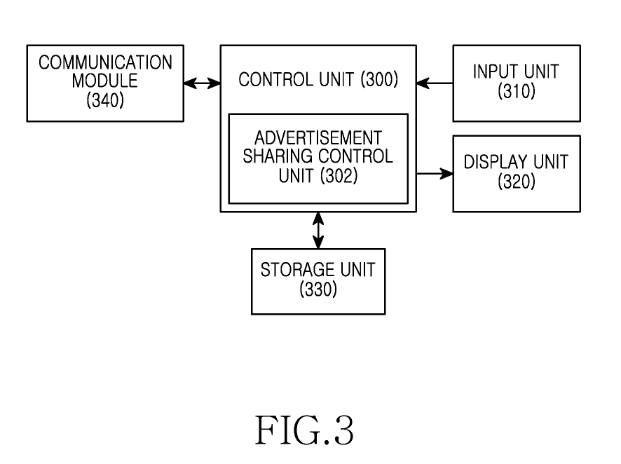

FIG. 3 is a block diagram of a user terminal according to an embodiment of the present invention.

Referring to FIG. 3, the terminal includes a control unit 300, an input unit 310, a display unit 320, a storage unit 330, and a communication module 340. The control unit 300 includes an advertisement sharing control unit 302.

The control unit 300 controls and processes an overall operation of the terminal. According to an embodiment, the control unit 300 controls and processes a function of receiving advertisement content from a service server and sharing the received advertisement content with other terminals.

When an advertisement sharing function is set in the terminal, the advertisement sharing control unit 302 determines whether there is a peripheral terminal capable of advertisement sharing (a counterpart terminal). When there is a counterpart terminal, the advertisement sharing control unit 302 exchanges advertisement sharing profiles with the counterpart terminal, performs an ad-hoc connection with the counterpart terminal, and shares advertisement content with the counterpart terminal. As shown in Table 1, the advertisement sharing control unit 302 performs an ad-hoc connection with the counterpart terminal on the basis of the “PreferredNetwork” information included in the advertisement sharing profile. The advertisement sharing control unit 302 determines whether to share advertisement content with the counterpart terminal, by comparing the advertisement preference field of the terminal and the advertisement preference field of the counterpart terminal included in the advertisement sharing profiles. When the advertisement preference field of the terminal is different from the advertisement preference field of the counterpart terminal, the advertisement sharing control unit 302 does not share advertisement content with the counterpart terminal. On the other hand, when the advertisement preference field of the terminal is identical to the advertisement preference field of the counterpart terminal, the advertisement sharing control unit 302 shares advertisement content with the counterpart terminal. For example, the advertisement sharing control unit 302 compares the advertisement content of the terminal and the advertisement content of the counterpart terminal on the basis of the advertisement content lists included in the advertisement sharing profiles, and communicates the advertisement content that are not included in the advertisement content lists.

The advertisement sharing control unit 302 creates and updates the advertisement sharing profile as shown in Table 1. The advertisement sharing control unit 302 creates an initial advertisement sharing profile, detect a change in the user's present advertisement content use status, the advertisement sharing, and the stored advertisement content, and update the initial advertisement sharing profile continuously. Also, the advertisement sharing control unit 302 feeds back log information and advertisement preference field information, which are generated according to the advertisement sharing and the use of advertisement content by the user, to an advertisement service server at predetermined periods or at every specific event.

The input unit 310 includes one or more function keys and touch sensors. The input unit 310 provides the control unit 300 with data corresponding to a key pressed by the user, or data corresponding to a user's touch. According to an embodiment, the input unit 310 receives information about an advertisement preference field, information about whether to use an advertisement sharing function, and information about an advertisement sharing target terminal, and provides the same to the control unit 300.

The display unit 320 displays numerals, characters, moving pictures, still pictures, and status information generated during an operation of the terminal. According to an embodiment, the display unit 320 displays advertisement content played under the control of the control unit 300. Also, the display unit 320 displays a list of advertisement content shared with the counterpart terminal.

The storage unit 330 stores various programs and data necessary for operating the terminal. According to an embodiment, the storage unit 330 stores advertisement content. Further, the storage unit 330 stores an advertisement sharing profile (as shown in Table 1) under the control of the control unit 300.

The communication module 340 communicates signals with another terminal in a wired or wireless manner under the control of the control unit 300. According to an embodiment, the communication module 340 feeds back advertisement use information to an advertisement service server, performs an ad-hoc connection with a counterpart terminal, and communicates signals with the counterpart terminal to share advertisement content with the counterpart terminal.

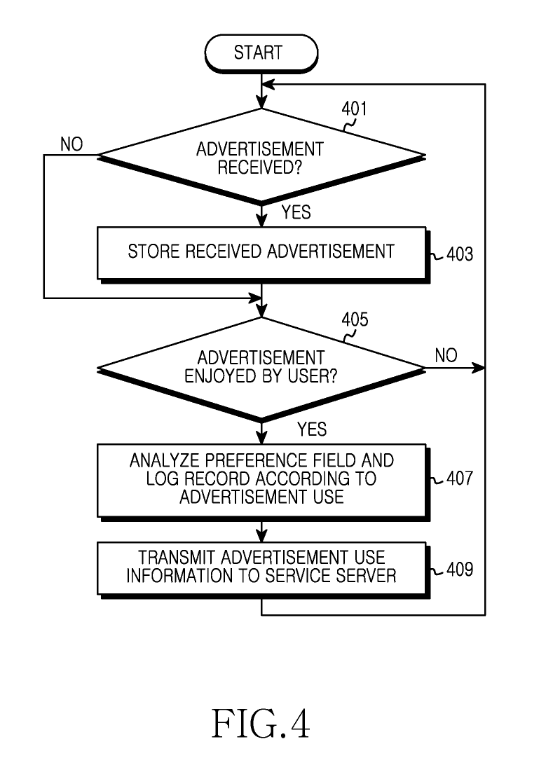

FIG. 4 is a flowchart illustrating an operation process of using advertisement content in a user terminal according to an embodiment of the present invention.

Referring to FIG. 4, in step 401, the terminal determines whether advertisement content is received. If the advertisement content is received, the terminal proceeds to step 405; otherwise, the terminal proceeds to step 403. In step 403, the terminal stores the received advertisement content. Herein, the advertisement content is received from a service server, or from an advertisement sharing target terminal.

In step 405, the terminal determines whether the stored advertisement content is used by the user. For example, the terminal determines whether the stored advertisement content is played by the user or transmitted to the ad-hoc connected counterpart terminal. If the stored advertisement content is used by the user, the terminal proceeds to step 407. In step 407, the terminal records log information according to the use of advertisement content and analyzes an advertisement preference field according to the user of advertisement content. The log information represents information and operations relevant to advertisement content in the terminal. Examples of the log information include an advertisement content use time, an advertisement content use period, an advertisement content use pattern, an advertisement content sharing time, shared advertisement content, and an advertisement content sharing pattern. The advertisement preference field according to the user of advertisement content is determined as the field corresponding to advertisement content that are frequently used by the user. For example, when the user views car advertisement videos frequently, the advertisement preference field of the user is determined as “car.”

In step 409, the terminal transmits advertisement use information to the service server. Herein, the terminal transmits the advertisement use information to the service server at predetermined periods or at the occurrence of an event such as a service connection or a feedback information request. The terminal uses the advertisement use information to create and update an advertisement sharing profile as shown in Table 1. The terminal then returns to step 401.

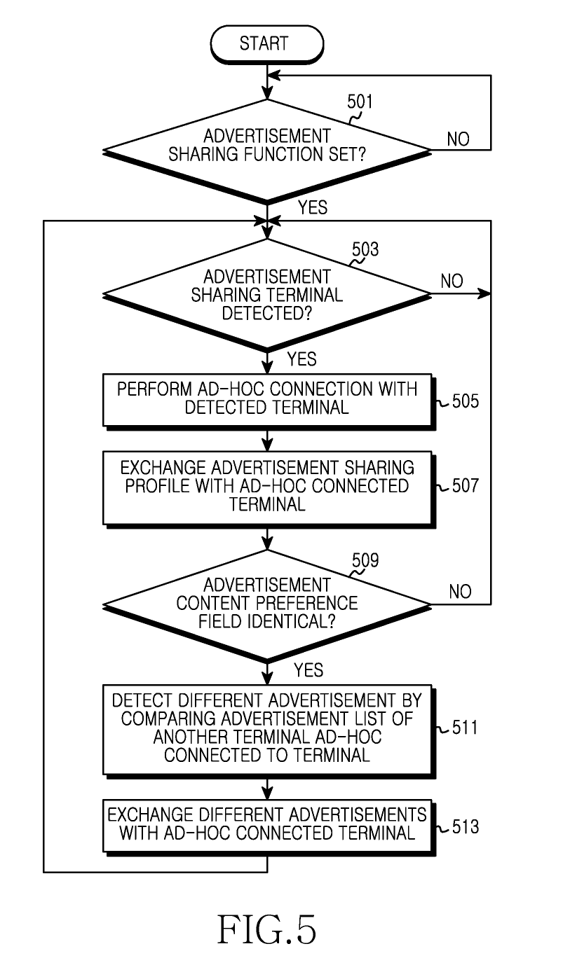

FIG. 5 is a flowchart illustrating an operation process of sharing advertisement content between a user terminal and another user terminal according to an embodiment of the present invention.

Referring to FIG. 5, in step 501, the terminal determines whether an advertisement sharing function is set therein. If the advertisement sharing function is set, the terminal proceeds to step 503. In step 503, the terminal determines whether an advertisement sharing target terminal is detected. In an embodiment, the terminal detects the presence of a peripheral advertisement sharing target terminal by transmitting/receiving an advertisement sharing request/response signal to/from the peripheral advertisement sharing target terminal according to a predetermined process. In another embodiment, the terminal detects the presence of a peripheral advertisement sharing target terminal by receiving an advertisement sharing request signal from the peripheral advertisement sharing target terminal. In another embodiment, the terminal detects the presence of a peripheral advertisement sharing target terminal on the basis of its location information. Also, the terminal detects the presence of an advertisement sharing target terminal when connected with another terminal in a wired manner.

If the advertisement sharing target terminal is detected, the terminal proceeds to step 505. In step 505, the terminal performs an ad-hoc connection with the counterpart terminal (e.g., the advertisement sharing target terminal). In step 507, the terminal exchanges advertisement sharing profiles with the counterpart terminal. The ad-hoc connection may be a wireless ad-hoc connection or a wired ad-hoc connection.

In step 509, the terminal determines whether its advertisement preference field is identical to the advertisement preference field of the counterpart terminal. For example, the terminal uses information, which is included in the advertisement sharing profiles exchanged in the ad-hoc connection process, to determine whether its advertisement preference field is identical to the advertisement preference field of the counterpart terminal.

If its advertisement preference field is not identical to the advertisement preference field of the counterpart terminal, the terminal stops the process for sharing advertisement content with the counterpart terminal, and returns to step 503.

At this point, the terminal releases the ad-hoc connection with the counterpart terminal.

However, if its advertisement preference field is identical to the advertisement preference field of the counterpart terminal, the terminal proceeds to step 511. In step 511, the terminal compares its own advertisement content list and the advertisement content list of the counterpart terminal to detect advertisement content that are present in its own advertisement content list but not in the advertisement content list of the counterpart terminal. In step 513, the terminal transmits the detected advertisement content to the counterpart terminal and receives advertisement content, which is present in the advertisement content list of the counterpart terminal but not in its own advertisement content list, from the counterpart terminal. The advertisement content list included in the advertisement sharing profile includes priority information indicating the user's use count and use time with respect to each of the advertisement content. The reason for this is that if the advertisement preference fields of two terminals are identical to one another, the advertisement content by one terminal is also be preferred by the other terminal. Thus, if there are a predetermined number or more of advertisement content that is present in its own advertisement content list but not in the advertisement content list of the counterpart terminal, the terminal transmits only a predetermined number of high-priority advertisement content to the counterpart terminal. The terminal then returns to step 503.

It has been described above that the present invention exchanges the advertisement sharing profiles, compares the information included in the advertisement sharing profiles, and communicates the sharing target advertisement content between the two terminals. However, because the advertisement sharing profile includes information about advertisement content of the terminal, the process of communicating advertisement content after exchanging the advertisement sharing profiles may be omitted. That is, because the advertisement sharing profile received from the counterpart terminal includes URL information about advertisement content of the terminal, the URL information is used to download the advertisement content.

As described above, the present invention provides an advertisement service considering the characteristics of users and shares advertisement content between user terminals of the same advertisement preference field, thereby making it possible to increase the advertisement effect.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. A method for providing an advertisement service in a terminal, comprising:
receiving advertisement content;
detecting use of the received advertisement content;
recording information containing an advertisement content use history when detecting the use of the advertisement content; and
transmitting the information containing the advertisement content use history to an advertisement service server.

2. The method of claim 1, wherein the information containing the advertisement content use history includes at least one of a necessity of advertisement sharing, an advertisement sharing target terminal, a capability of the terminal, an advertisement preference field, log information indicating the advertisement content use history, a preferred network, a list of advertisement content stored in a terminal, a Uniform Resource Locator (URL) of each advertisement content, and a priority of each advertisement content.

3. The method of claim 2, further comprising:
detecting a peripheral terminal having an advertisement sharing function;
transmitting the information containing the advertisement content use history to the peripheral terminal; and
receiving information containing an advertisement content use history from the peripheral terminal.

4. The method of claim 3, further comprising:
comparing the advertisement preference field of the terminal with the advertisement preference field of the peripheral terminal;
comparing an advertisement content list of the terminal with the advertisement content list of the peripheral terminal when the advertisement preference field of the terminal is identical to the advertisement preference field of the peripheral terminal; detecting advertisement content present in the advertisement content list of the terminal but not in the advertisement content list of the peripheral terminal; and
transmitting the searched advertisement content to the peripheral terminal.

5. The method of claim 4, wherein detecting the advertisement content comprises:
when a plurality of advertisement content in the advertisement content list of the terminal but not in the advertisement content list of the peripheral terminal are detected, determining the priority of each of the searched advertisement content; and
selecting at least one advertisement content to be transmitted to the peripheral terminal according to the determined priority.

6. The method of claim 4, further comprising:
receiving at least one advertisement content, which are present in the advertisement content list of the peripheral terminal but not in the advertisement content list of the terminal, from the peripheral terminal.

7. The method of claim 3, wherein the peripheral terminal is a terminal designated by a user or a terminal having the advertisement sharing function.

8. The method of claim 3, further comprising:
connecting the terminal and the peripheral terminal through the preferred network.

9. The method of claim 2, wherein the log information indicating the advertisement content use history includes at least one of an advertisement content use time, an advertisement content use period, an advertisement content use pattern, an advertisement content sharing time, shared advertisement content, and an advertisement content sharing pattern.

10. The method of claim 1, wherein the advertisement content is received from the advertisement service server or another connected terminal, and detecting the use of the received advertisement content includes detecting play by a user or transmission to another connected terminal.

11. An apparatus of a terminal for providing an advertisement service, the apparatus comprising:
a communication module for receiving advertisement content; and
a control unit for detecting use of the received advertisement content, recording information containing an advertisement content use history when detecting the use of the advertisement content, and transmitting the information containing the advertisement content use history to an advertisement service server.

12. The apparatus of claim 11, wherein the information containing the advertisement content use history includes at least one of a necessity of advertisement sharing, an advertisement sharing target terminal, a capability of a the terminal, an advertisement preference field, log information indicating the advertisement content use history, a preferred network, a list of advertisement content stored in a terminal, a Uniform Resource Locator (URL) of each advertisement content, and a priority of each advertisement content.

13. The apparatus of claim 12, wherein the control unit controls the communication module to detect a peripheral terminal having an advertisement sharing function, transmit the information containing the advertisement content use history to the peripheral terminal, and receive information containing an advertisement content use history from the peripheral terminal.

14. The apparatus of claim 13, wherein the control unit compares the advertisement preference field of the terminal with an advertisement preference field of the peripheral terminal, compares an advertisement content list of the terminal with an advertisement content list of the peripheral terminal when the advertisement preference field of the terminal is identical to the advertisement preference field of the peripheral terminal, and detects at least one advertisement content present in the advertisement content list of the terminal but not in the advertisement content list of the peripheral terminal, and transmits the detected advertisement content through the communication module to the peripheral terminal.

15. The apparatus of claim 14, wherein when a plurality of advertisement content present in the advertisement content list of the terminal but not in the advertisement content list of the peripheral terminal are detected, the control unit determines the priority of each of the detected advertisement content, and selects at least one advertisement content to be transmitted to the peripheral terminal according to the determined priority.

16. The apparatus of claim 14, wherein the control unit receives at least one advertisement content, which are present in the advertisement content list of the peripheral terminal but not in the advertisement content list of the terminal, from the peripheral terminal through the communication module.

17. The apparatus of claim 13, wherein the peripheral terminal is a terminal designated by a user or a terminal having an advertisement sharing function.

18. The apparatus of claim 13, wherein the control unit controls the communication module to connect the terminal and the peripheral terminal through the preferred network.

19. The apparatus of claim 12, wherein the log information indicating the advertisement content use history includes at least one of an advertisement content use time, an advertisement content use period, an advertisement content use pattern, an advertisement content sharing time, shared advertisement content, and an advertisement content sharing pattern.

20. The apparatus of claim 11, wherein the advertisement content is received from the advertisement service server or another connected terminal, and the control unit detects the use of the received advertisement content by determining whether the received advertisement content is played by a user or transmitted to another connected terminal.
